(19) United States
(12) Patent Application Publication
(10) Pub. No.: US 2004/0262294 A1
(43) Pub. Date: Dec. 30, 2004

(54) SERPENTINE CONDUCTIVE PATH FOR WOVEN SUBSTRATES

(76) Inventors: Leonard I. Horey, Boca Raton, FL (US); Armando Alvite, Miami, FL (US)

Correspondence Address: Lawrence J. Shurupoff, Sunbeam Products, Inc., 2381 Executive Center Drive, Boca Raton, FL, 33431, US

(21) Appl. No.: 10/603,045

(22) Filed: Jun. 24, 2003

(51) Int. Cl. H05B 3/34; H05B 3/10

(52) U.S. Cl. 219/545; 219/548

(57) ABSTRACT

A serpentine conductive path has a plurality of generally parallel wires, a pair of conductive busses running generally parallel to one another and generally perpendicular to the wires, wherein the wires are electrically connected to the conductive busses, and wherein the conductive busses further include a plurality of isolation punches so as to form an electrically conductive serpentine pattern in conjunction with the wires. The wires may be formed of positive temperature coefficient material for sensing and controlling the temperature of a heating fabric.

### BACKGROUND OF THE DISCLOSURE

1. Field of the Disclosure

This invention relates to serpentine conductive paths in woven substrates.

2. Description of the Related Art

It is known to provide fabric, such as electric blankets, with temperature sensors and heating elements. The manufacture and placement of such sensors within the blanket adds to the production cost of the blanket. This is especially true for serpentine sensors and heating elements, which owe their shape to the desire to cover a wide area of the blanket. These serpentine elements must be added after manufacture of the blanket fabric itself and positioned and fixed in the serpentine pattern.

What is needed is a means of simultaneously creating the fabric material and the serpentine elements, so as to realize substantial savings in cost and time.

### BRIEF SUMMARY OF THE DISCLOSURE

Disclosed is a serpentine conductive path including a plurality of generally parallel wires, a pair of conductive busses running generally parallel to one another and generally perpendicular to wires, wherein the wires are electrically connected to the conductive busses, and wherein the conductive busses further include a plurality of isolation punches so as to form an electrically conductive serpentine pattern in conjunction with the wires.

In another aspect of the invention, the wires and busses are incorporated into a woven substrate.

In another aspect of the invention, the wires and busses are woven into said woven substrate.

In another aspect of the invention, the wires are temperature sensitive.

In another aspect of the invention, the wires have a positive temperature coefficient of resistivity.

In another aspect of the invention, the wires are crimped to the busses.

In another aspect of the invention, the wires are welded to the busses.

In another aspect of the invention, the woven substrate is an electric blanket.

Another aspect of the invention includes a plurality of heating busses in electrical conduction with a plurality of heating wires.

In another aspect of the invention, one of the heating busses is in electrical conduction with one end of the serpentine conductive path.

Disclosed is a method of manufacturing a woven substrate having a serpentine conductive path therein, comprising the steps of weaving the woven substrate of an electrically non-conductive material, weaving into the woven substrate a plurality of generally parallel wires, weaving into the woven substrate a pair of conductive busses running generally parallel to one another and generally perpendicular to the wires, electrically connecting the wires to the conductive busses, and punching isolation holes into the conductive busses so as to form an electrically conductive serpentine pattern in conjunction with the wires.

Another aspect of the method of the invention further comprises the step of weaving into the woven substrate a heating element.

In another aspect of the method of the invention, the weaving of a heating element further includes the steps of weaving into the woven substrate a plurality of heating wires, and weaving into the woven substrate a plurality of heating busses running substantially perpendicular to the heating wires and in electrical conduction therewith.

### BRIEF DESCRIPTION OF THE DRAWINGS

In the Drawings:

FIG. 1 shows a weave substrate of the invention.

FIG. 2 shows the weave substrate of FIG. 1 after a hole punch operation.

FIG. 3 shows the weave substrate of FIG. 2 after an electrical connection operation.

FIG. 4 shows the weave substrate of FIG. 3 with an electrical plug provided.

### DETAILED DESCRIPTION OF THE PREFERRED EMBODIMENTS

Referring generally to FIG. 1, there is shown a woven substrate 10, which will generally be in the form of a fabric weave. For example, if the substrate is an electric blanket or other heated fabric (e.g., electrically heated clothing, heated sleeping bags, heated beds, etc.), a plurality of heater busses 12a and 12b may be provided that conductively attach to the end portions of a plurality of heating wires 14. In a preferred version of this embodiment, a cross connector 15 is provided, generally perpendicular to the heating busses, that conductively attaches to the heater busses for reasons that will become apparent below.

Also provided are a set of sensor busses, 22a and 22b that conductively attach to the heater busses 12a, 12b. Overlapping the sensor busses 22a, 22b are a plurality of sensor wires or strands 20 that are not conductively attached to either the sensor busses 22a, 22b or the cross connector 15.

The configuration shown in FIG. 1 is preferred for a weave because of its ease of manufacture. Note that the various busses and wires are simply warp and weft woven, permitting of continuous manufacture. Electrical contact between the heating wires 14 and the heating busses is easily accomplished by leaving both uninsulated. The heating wires 14 will generally be either a conductive wire or thread (e.g., nichrome wire, conductive polymer, carbon-impregnated thread) or a conductor-coated thread of material, such as a silver-coated thread, that is of such resistance as to generate heat at the voltages and currents utilized. The busses 12a, 12b, 22a, 22b and cross-connector 15 may be of similar material or, more preferably, flat strips of conductive material, such as conductive polymers, or copper, brass, or aluminum strips or foils.

Electrical contact between the sensor wires 20 and the sensor busses 22a, 22b and cross-connector 15 may be avoided by simply insulating these wires.

The sensor wires 20, which are provided for measuring the temperature of the substrate 10, preferably made of a temperature sensitive material, such as a positive temperature coefficient (PTC) polymer, meaning the resistivity of the material goes up with increasing temperature. Typically, the PTC material will be a polymer infused with a conductive material, such as polyethylene infused with carbon powder as is described in Kelly, U.S. Pat. No. 4,277,673, issued Jul. 7, 1981, for an Electrically Conductive Self-Regulating Article, the disclosure of which is incorporated by reference herein in its entirety. The heater busses 12 may also be made of a PTC material.

Any material that displays a positive temperature coefficient is essentially a thermistor so that the temperature of the substrate 10 may be measured by changes in voltage across and/or current through a PTC material. It is advantageous to configure this thermistor as a serpentine conductive path, so that it may detect temperature over the entire surface of the fabric.

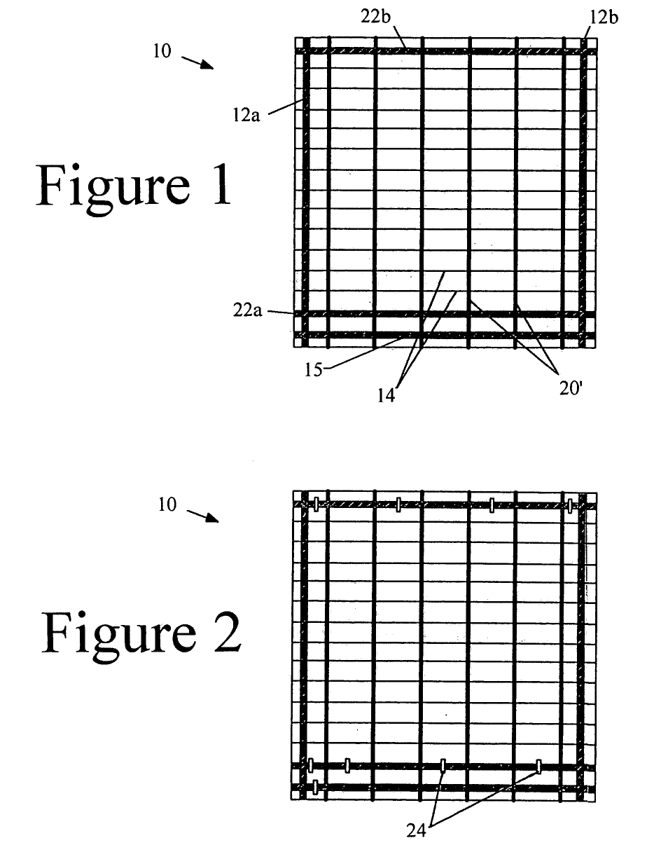

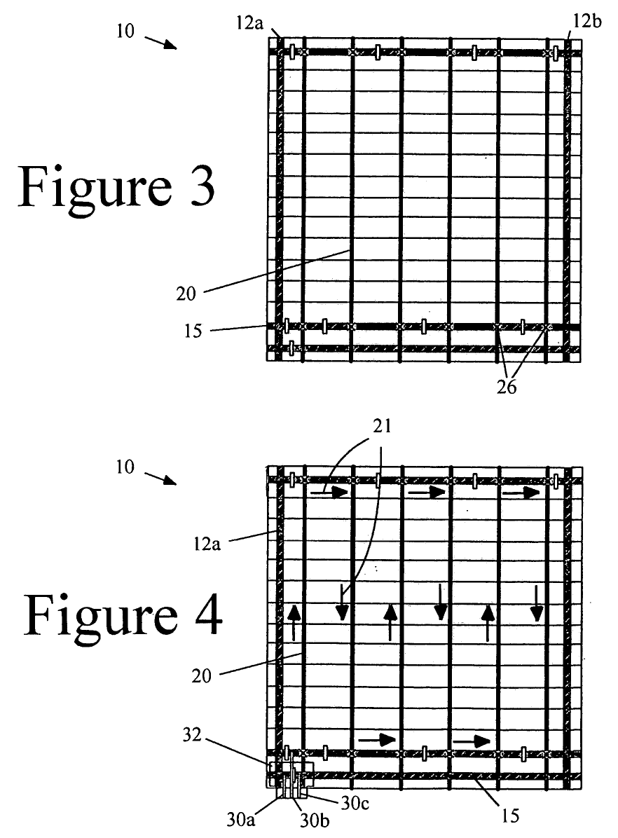

Referring to FIGS. 2 and 3, a plurality of isolation holes 24 between the sensor wires and the sensor busses is provided in the sensor busses 22a, 22b and a plurality of electrical connections 26 are made so that the sensor wires 20 are now in conductive attachment to the sensor busses 22a, 22b. As can now be seen, a serpentine conductive path 21 is thus formed by the series of electrical connections 26 and staggered isolation holes 24. An additional isolation hole may be provided to isolate the cross-connector 15 from one of the heater busses 12a. The electrical attachments may be effected though a number of means, such as by crimping on a crimp connection, conductive adhesive, spot welding and other means known in the art. The crimp connection would generally be effected by having a two-piece connector, each piece having conductive “teeth,” wherein each piece is pressed into the fabric from opposite sides of the plane of the fabric.

It is preferable that the sensor wires 20 and the sensor busses 22a, 22b have different optical properties from one another and from the surrounding fabric so that the hole and connection points may be located by optical scanning.

Referring to FIG. 4, a set of connectors 30, such as pin connectors, is provided that allow outside electrical access to the heater busses 12a, 12b and the serpentine path 21 identified by the directional arrows in FIG. 4. As can be seen, the optional cross-connector 15 allows the plug connectors 30 to be disposed close together and encased in a plug 32. Hence, pin 30a connects to one heater bus 12a, pin 30b connects to one end of the serpentine conductive path 21, and pin 30c connects to the cross-conductor 15. Typically, for use as a temperature sensor, the serpentine path 21 is provided with some small voltage, such a five volts or other voltage suitable for a computer. The output signal from the temperature sensor formed by the serpentine path 21 could then be easily inputted into a computer.

In the embodiment shown, one of the heater busses 12b is used as a common bus for both the heater wires 14 and the serpentine sensor 21. This is more economical than adding an additional cross-connector and plug connection, but it should be noted that this configuration would generally only be used for low-voltage heated fabrics (e.g., about thirty volts) because it would not be desirable to have a common connection between high and low voltages. Note also that if high voltages are applied to the heater busses 12a, 12b, such as 120 volts house voltage, it would also be necessary to electrically insulate the heater busses 12a, 12b and heater wires 14 to avoid a shock hazard. This means the heater wires 14 would also have to be attached to the heater busses 12a, 12b, such as by crimp connections.

While various values, scalar and otherwise, may be disclosed herein; it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

1. A serpentine heat sensor path comprising:
a plurality of generally parallel temperature-sensitive sensor wires running generally perpendicular to a plurality of heating wires and electrically insulated therefrom and within a distance sufficient to sense heat generated by said heating wires;
a pair of conductive sensor busses running generally parallel to one another and generally perpendicular to said sensor wires;
wherein said sensor wires are electrically connected to said sensor busses; and
wherein said sensor busses further comprise a plurality of isolation punches so as to form an electrically conductive serpentine pattern in conjunction with said sensor wires.

2. The apparatus of claim 1 wherein said sensor wires and sensor busses are incorporated into a woven substrate.

3. The apparatus of claim 2 wherein said sensor wires and sensor busses are woven into said woven substrate.

4. The apparatus of claim 1 wherein said sensor wires are temperature sensitive.

5. The apparatus of claim 1 wherein said sensor wires have a positive temperature coefficient of resistivity.

6. The apparatus of claim 1 wherein said sensor wires are crimped to said sensor busses.

7. The apparatus of claim 1 wherein said sensor wires are welded to said sensor busses.

8. The apparatus of claim 3 wherein said wires are temperature sensitive.

9. The apparatus of claim 3 wherein said sensor wires have a positive temperature coefficient of resistivity.

10. The apparatus of claim 3 wherein said sensor wires are crimped to said sensor busses.

11. The apparatus of claim 3 wherein said sensor wires are welded to said sensor busses.

12. The apparatus of claim 3 wherein said woven substrate is an electric blanket.

13. The apparatus of claim 3 further comprising a plurality of heating busses in electrical conduction with said heating wires.

14. The apparatus of claim 13 wherein one of said heating busses is in electrical conduction with one end of the serpentine conductive path.

15. A method of manufacturing a woven substrate having a serpentine heat sensor path therein, comprising the steps of:
weaving the woven substrate of an electrically non-conductive material;
weaving into the woven substrate a plurality of generally parallel temperature-sensitive sensor wires;
weaving into the woven substrate a pair of conductive sensor busses running generally parallel to one another and generally perpendicular to said sensor wires;
electrically connecting said sensor wires to said sensor busses; and
punching isolation holes into said sensor busses so as to form an electrically conductive serpentine pattern in conjunction with said sensor wires.

16. The method of claim 15 further comprising the step of weaving into the woven substrate a heating element.

17. The method of claim 16 wherein said weaving of a heating element further comprises the steps of:
weaving into the woven substrate a plurality of heating wires;
weaving into the woven substrate a plurality of heating busses running substantially perpendicular to said heating wires and in electrical conduction therewith.

18. The method of claim 15 wherein the sensor busses have different optical properties than that of woven substrate and are located by optical scanning in order to perform the punching operation.

19. A method of manufacturing a woven substrate having a serpentine conductive path therein, comprising the steps of:
weaving the woven substrate of an electrically non-conductive material;
weaving into the woven substrate a plurality of generally parallel wires;
weaving into the woven substrate a pair of conductive foil busses running generally parallel to one another and generally perpendicular to said wires;
electrically connecting said wires to said conductive busses; and
punching isolation holes into said foil busses so as to form an electrically conductive serpentine pattern in conjunction with said wires.

20. The method of claim 19 wherein the foil busses have different optical properties than that of woven substrate and are located by optical scanning in order to perform the punching operation.
